(19) United States
(12) Patent Application Publication
(10) Pub. No.: US 2013/0233597 A1
(43) Pub. Date: Sep. 12, 2013

(54) WIRING DRESSING RINGS

(71) Applicant: Robert R. Suiter, Hayward, CA (US)

(72) Inventor: Robert R. Suiter, Hayward, CA (US)

(21) Appl. No.: 13/556,137

(22) Filed: Jul. 23, 2012

Related U.S. Application Data
(60) Provisional application No. 61/609,788, filed on Mar. 12, 2012.

(51) Int. Cl. H01B 17/00

(52) U.S. Cl. 174/135

(57) ABSTRACT

A cable dressing ring for organizing a cable bundle is provided, wherein, the ring is separated in two halves that are associated by a joint mechanism at one end, and that are securable to each other by a locking mechanism at the other end, such that a user may lock the ring when needed to clamp the ring around the inner cables of the bundle, and wherein, the ring has a plurality of self-locking cable holders on the outside circumference of the ring, for holding the outer cables of the bundle organized while pulling the ring toward one end of the bundle.

### CROSS-REFERENCE TO RELATED APPLICATIONS

This application claims the benefit of U.S. Provisional Application No. 61/609,788, filed Mar. 12, 2012, which is hereby incorporated by reference, to the extent that it is not conflicting with the present application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates a tool for neatly organizing cable bundles.

2. Description of the Related Art

When cabling technicians pull cables (or wires) throughout a building, they pull from a computer room for example, and they typically end up with a large bundle of cables. The large bundle of cables, throughout the building, as well as all the cables throughout the computer room, and/or throughout a computer rack, has to be neatly organized so that the job appears professional. It is well known that cables have a natural tendency to entangle themselves, and untangling them is very difficult and tedious work. Furthermore, after the untangling, manually organizing the cables is a tedious and time consuming job as well. Thus, the entire process is also very expensive.

While there are some tools available on the market to help cable technicians address these problems, those tools are flawed as they do not sufficiently eliminate the tediousness, frustration and the high cost associated with the process of cable dressing. For example, some of the tools require that the technician untangle and organize all cables, which is a waste of time and money as the inner cables will not be seen, and thus, do not need to be organized. There are other tools on the market that focus on the outer cables only, however, they require the technician to use tape or Velcro to hold the parts of the tools together and hold the cables into the tool. The use of the tape is tedious, frustrating and time consuming itself, and the parts of the tool held by tape or Velcro often make the tool insufficiently robust for the job at hand. Furthermore, a significant amount of experience is needed before a technician can efficiently and effectively dress cable bundles using these tools, which makes the cost of training an apprentice significantly high. Thus, there is a need for an improved tool that addresses the deficiencies of existing tools.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, a cable dressing ring is provided, which is separated in two halves that are associated by a joint mechanism (e.g., a hinge) at one end, such that the ring can be opened and closed by a user as needed, and that are securable to each other by a locking mechanism, such that the user may easily lock and unlock the ring as needed; and having a plurality of locking cable holders on the outside circumference of the ring. Thus, an advantage is that there is no frustration, tediousness, and time wasted associated with the holding of the two halves of the ring together when needed. A simple, quick, and effortless action (e.g., a simple push), by the user, locks the ring, thus obtaining a robust tool to pull on. Another advantage is that the outer cables of a bundle lock into the cable holders, thus eliminating the need for the laborious and frustrating process of securing the cables to the ring using tape or Velcro.

The above embodiment and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1a illustrates the perspective view of a wiring dressing ring 100, according to an embodiment of the invention.

FIG. 1b illustrates a partial side view of the wiring dressing ring 100 from FIG. 1a and a pivot 117.

FIG. 2 illustrates the top view of the wiring dressing ring 100 from FIG. 1a.

FIG. 3 illustrates a partial perspective view of the wiring dressing ring 100 from FIG. 1a, providing a closer view of the joint mechanism 105.

FIG. 4 illustrates a partial perspective view of the wiring dressing ring 100 from FIG. 1a, providing a closer view of locking mechanism 107.

FIG. 5 illustrates various sizes and versions, in closed or open position, of the wiring dressing ring disclosed herein, according to other embodiments.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

Throughout this disclosure, the term “wiring dressing ring” is used interchangeably with the following synonymous terms: “cable dressing ring,” “dressing ring,” “dress ring,” “cable ring” and “ring.” Furthermore, the term “wire” and its derivatives are used herein interchangeably with the synonymous term “cable” and its derivatives. The wires or cables referred to herein may be of any type, such as coaxial cable, audio cable, data cable, telephone cable, network cable, and so on.

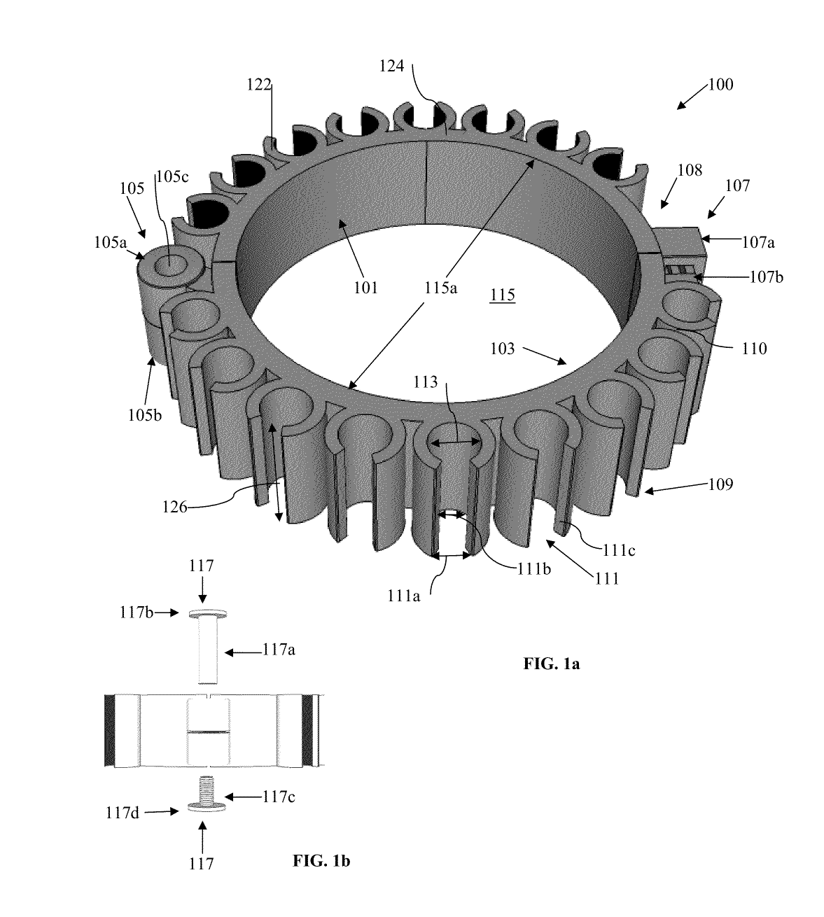

FIG. 1a illustrates the perspective view of a wiring dressing ring 100, according to an embodiment of the invention. As shown, the wiring dressing ring 100 resembles a ring (or a sprocket) separated in two halves, a first half 101 and a second half 103. The two ring halves (101 and 103) are associated with each other at one end by a joint mechanism 105 (e.g., a hinge) such that the ring can opened and closed by a user (e.g., a technician) as needed, as it will be explained in details below. At the other end, the two halves (101, 103) may be secured to each other by a locking mechanism 107, such that the user may manually and easily lock and unlock the ring 100 as needed, as it will also be explained in details below.

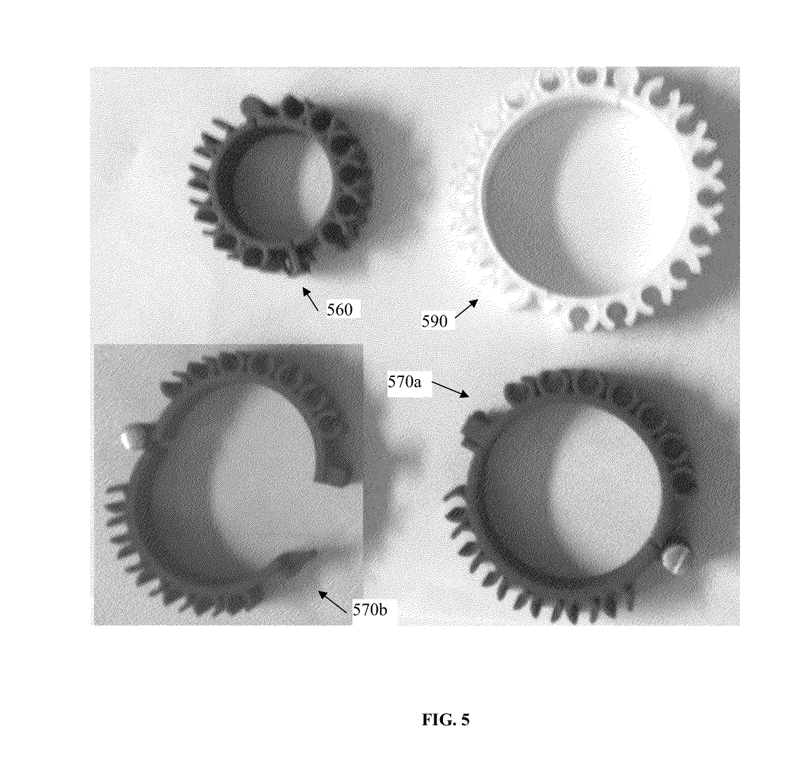

As shown, on the outside circumference the dress ring 100 has a plurality of cable holders 109, placed next to each other and with a gap 110 between them. On the inside, as shown, the dress ring 100 has an opening 115 having a diameter 115a sized to accommodate a desired number of inner cables in a bundle (e.g., 10 coaxial cables (not shown)), as it will be explained later herein. It should be noted that, as shown in FIG. 5, there is a correlation between the number of cables holders 109 that the dress ring 100 may have and the outer diameter of the ring. Thus, smaller dress rings having, for example, six or seven cable holders on each side, thus a total of twelve or fourteen, (see 560 and 570a in FIG. 5), or larger dress rings having eighteen cable holders (see 590 in FIG. 5) or more, may be made, to assist a user in dressing bundles having a various number of cables. It should be apparent that a dress ring with, for example, twelve cable holders, may be used to dress a cable bundle having twelve outer cables or less and a certain number of inner cables (e.g., ten or less).

The thickness of the dress ring 100 and its elements described herein may vary depending on the materials used to make the ring. For example, if hard plastic is selected, the base 124 of the dress ring 100 may preferably be approximately between 1/8 and 1/4 of an inch thick, the thickness of the walls 122 of the cable holders 109 may preferably be approximately between 1/16 and 1/8 of an inch, while the height 126 of the dress ring 100 may preferably be approximately between 1/2 of an inch and 1.0 (one) inch. However, other values for the thicknesses and ring height may be adopted as long as the functionality of the dress ring as described herein is maintained.

As shown in FIG. 1a, the cable holders 109 have a cylinder-like shape in which an aperture 111 was cut to allow the forced insertion of a cable in the holder. The inside diameter 113 of cable holders 109 is preferably the same for all cable holders and sized to fit a particular size of the cable for which the dress ring 100 is intended to be used. It should be noted however, that the same dress ring may be used for various cable sizes as long as they may be pushed through aperture 111 into the cable holder 109 without escaping from it. It should be apparent that for this to happen, the approximate diameter of the cable has to be greater than the inside width 111b of the aperture 111, such that the cable cannot escape from the cable holder 109 (i.e., the cable is locked in) once it has been pushed/forced in by the technician. Alternatively, the dress ring 100 may be designed such that it has cable holders 109 of various sizes, such that it may better serve a user/technician who needs to neatly bundle cables of various sizes.

As shown in FIG. 1a, the cross-section of the aperture 111 has a trapezoidal or a trapezoid-like shape as the inside width 111b is smaller than the outside width 111a of the aperture 111. Because of this configuration, the aperture 111 can easily receives a cable, which is typically of circular shape, and further, it may facilitate cable's temporary sitting therein, while the cable is being pushed by the user into the cable holder 109. As shown, the two opposing side surfaces 111c of the aperture 111 may be flat. However, they may also be concave, to further facilitate cable's receipt and temporary sitting therein (while being forced into the cable holder 109).

Thus, it should be understood that the cable holders 109 are self-locking: once the cable is inside the cable holder, it cannot come out by itself. A user will be able to pull it out however, should the need arise.

The gaps 110 between the cable holders 109 may facilitate the forced entry of the cables into the cable holders 109, especially when a material (e.g., plastic, hard rubber, etc) with a given degree of elasticity/flexibility is chosen to manufacture the dress ring 100. In that case, each side of the aperture 111 may slightly spring away from the aperture's center, while the cable is being pushed/forced in, and they will then spring back into the original position, once the cable passed through aperture 111 and is thus inside the cable holder 109. However, completely rigid materials may be used as well as typically the cables' exterior cover and/or insulation is itself elastic/flexible enough to facilitate the forced entry of the cable into the cable holder 109, through the aperture 111, of which, again, at least the inside width 111b is smaller than the diameter of the cable.

As shown in FIG. 1a, the joint mechanism 105 may have a first joint member 105a associated with one of the halves (103) of the dress ring 100, and a second joint member 105b associated with the other half (101). Furthermore, as shown, the two members may have a cylindrical shape and each may have a through-hole 105c in the middle, to receive, for example, a two-part pivot 117 (see FIG. 1b), having a female-threaded element (117a) and a male-threaded element (117c), each having a head (117b and 117d), for creating a secure joint. As shown, each of the joint members (105a and 105b) preferably forms with the respective half of the dress ring 100 a unit which may be obtained by, for example, molding them together as one piece. Other types of pivots and/or joint mechanism may be used as long as secure pivotal movement is permitted such that the dress ring 100 may be easily opened and closed by the user and the joint is strong enough for ring's application described herein. For example, the joint mechanism may be a separate standard hinge (e.g., a strap hinge) which may be secured via screws to the two halves of the dress ring. However, the joint mechanism disclosed herein has the advantage that it is inexpensive to manufacture and that it provides the necessary strength needed to dress cables using the dress ring 100, as it will be explained later herein.

As mentioned earlier, at the other ends of the two halves (101, 103) of the dress ring 100, may be secured to each other by a locking mechanism 107 (e.g., a clasp), such that the user may easily lock and unlock the ring 100 as needed. As shown, the locking mechanism 107 may also have two members: a first locking member 107a associated with first half 101 of dress ring 100 and a second locking member 107b associated with the second half 103.

Similarly as for the joint mechanism, the two members (107a and 107b) of the locking mechanism may be manufactured as one-piece (a unit) with the respective half of the dress ring, such as by molding them together during manufacturing. Again, this approach is less expensive than later attaching a locking mechanism to the ring by, for example, using screws. The locking mechanism 107 may be a hook-and-loop type or any other type that is secure enough for the ring's application described herein while facilitating easy and fast engagement-disengagement by the user.

Thus, the dress ring 100 may be manufactured by, for example, injecting plastic into a mold. If this manufacturing process is chosen, two molds are preferably needed only, as explained above: one mold for the first half 101 of the ring having a joint member (105b) at one end, and a locking member (107a) at the other end; and a second mold for the second half 103 having a joint member (105a) at one end, and a locking member (107b) at the other end. Thus, the entire dress ring 100 is preferably made of a first half 101 and second half 103, which are easily and inexpensively joined together after manufacturing by a pivot 117.

It should be understood that additional materials, such as aluminum, or manufacturing processes, such as machining or extrusion, may be used as well.

It should be noted that the number of cable holders 109 shown in FIG. 1a is nine on the second half 103 of the dress ring 100, and only eight on one first half 101. This is because the space 108 is preferably needed between the locking mechanism 107 and the immediately adjacent cable holder such that the user can easily and quickly disengage the locking mechanism 107 when needed to open the dress ring 100. However, alternative configurations may be used such as by adopting a locking mechanism 107 which would permit easy and quick disengagement by the user without the need of space 108; thus, an additional cable holder may be then present in space 108.

In order to neatly organize a cable bundle using a dress ring 100, first, if various sizes of the ring are available as described earlier, a user will typically select a ring that can dress a total number of cables equal to or greater than the total number of cables in the bundle. For example, if the bundle has 24 cables, the user will need a dress ring that can dress 24 cables (or more) such as by having a diameter 115a large enough to allow the passage through opening 115 of 10 cables (or more) and having 14 cable holders 109. Next, the user will open the dress ring 100 by disengaging the locking mechanism 107 (see 570b in FIG. 5). Next, the user will clamp the dress ring 100 around the 10 inner cables of the bundle and will engage the locking mechanism 107, such that the dress ring 100 is in closed/locked position. It should be noted that the inner cables do not need to be untangled by the user/technician, because they will be ultimately hidden by the neatly arranged/dressed outer cables, thus achieving the same positive result, of neatly appearing bundle, in significantly less time.

Next, the user will insert the 14 outer cables of the bundle into the 14 cable holders 109 of the dress ring 100. As explained and described earlier, because of the specific attributes of the cable holders 109, the cables will be held into the cable holders without the need for any additional securing means. Next, the user will pull the dress ring 100 toward one end of the bundle, and thus, cause the outer cables to neatly organize around the inner cables. As the user pulls the dress ring in the direction selected, the bundle may be wrapped using tape, cable straps, or the like, such that the neatly organized bundle by the dress ring 100 is maintained as such. This process is continued for the entire length of the bundle that needs to be organized.

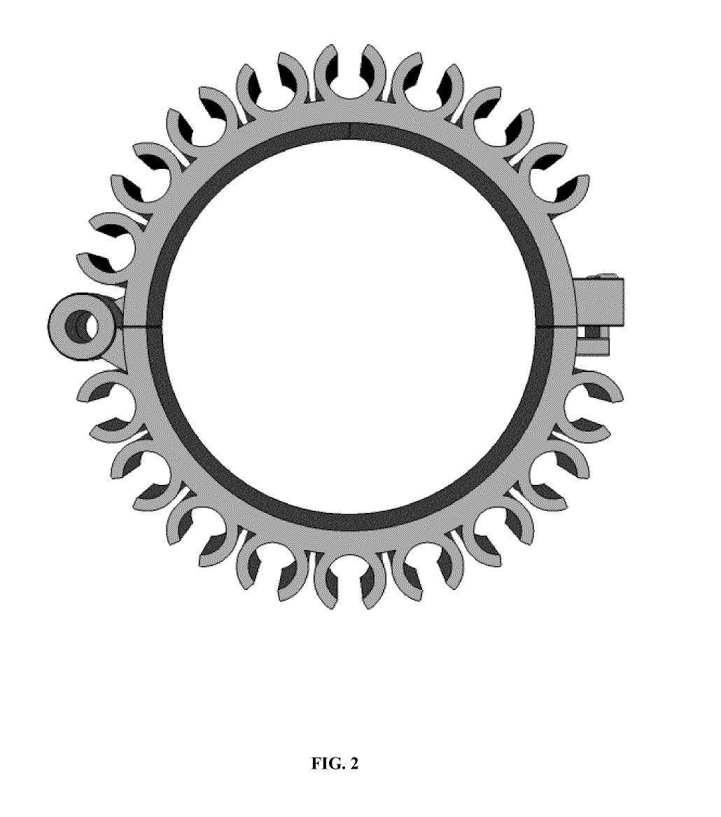

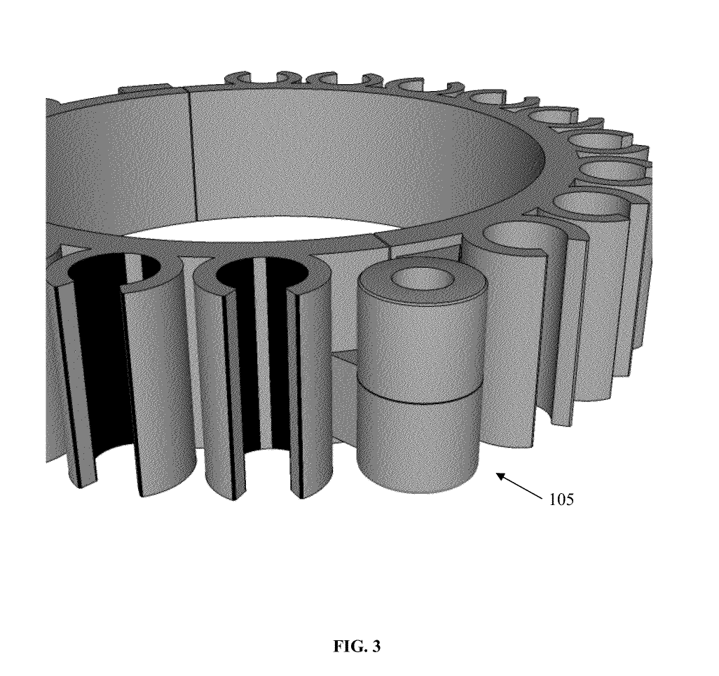

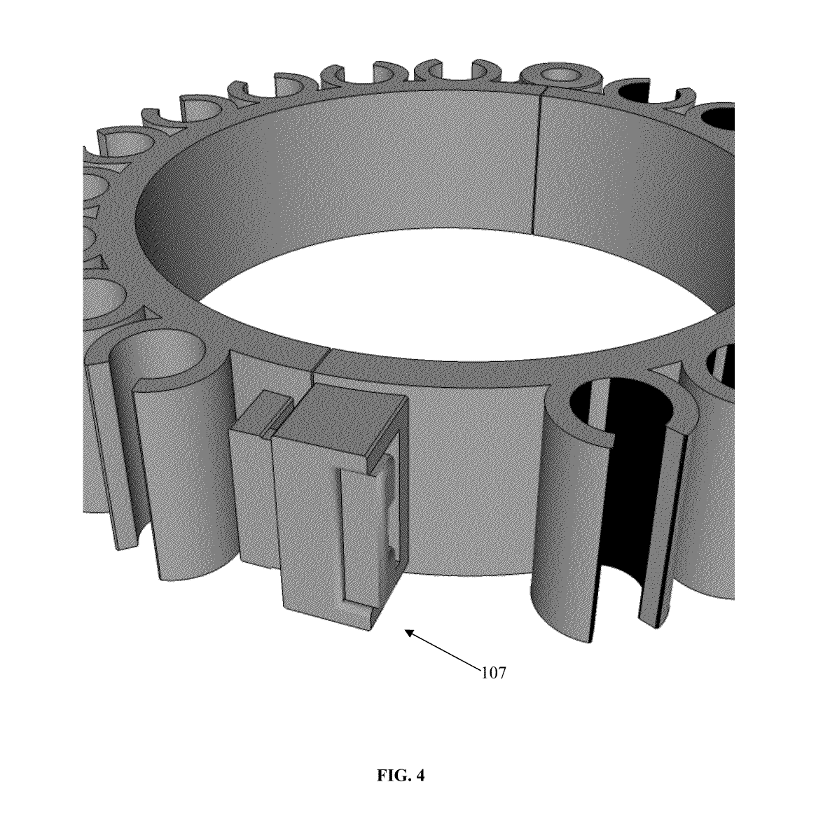

As stated earlier, FIG. 2 illustrates the top view of the wiring dressing ring 100 from FIG. 1a. FIG. 3 illustrates a partial perspective view of the wiring dressing ring 100 from FIG. 1a, providing a closer view of the joint mechanism 105. FIG. 4 illustrates a partial perspective view of the wiring dressing ring 100 from FIG. 1a, providing a closer view of locking mechanism 107. FIG. 5 illustrates various sizes and versions, in closed or open position, of the wiring dressing ring disclosed herein, according to other embodiments.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A cable dressing ring for organizing a cable bundle, wherein, the ring is separated in two halves that are associated by a joint mechanism at one end, and that are securable to each other by a locking mechanism at the other end, such that a user may lock the ring when needed to clamp the ring around the inner cables of the bundle, and wherein, the ring has a plurality of self-locking cable holders on the outside circumference of the ring, for holding the outer cables of the bundle organized while pulling the ring toward one end of the bundle.

2. The cable dressing ring of claim 1, wherein the cable holders have a cylinder-like shape in which an aperture was cut to allow the forced insertion of a cable into the holder by a user.

3. The cable dressing ring of claim 2, wherein the aperture has a trapezoidal cross-section.

4. The cable dressing ring of claim 3, wherein there is a gap between the cable holders such that each side of the aperture may spring away from the aperture's center, while a cable is being forced into a cable holder.

5. The cable dressing ring of claim 4, wherein the ring has seventeen cable holders, eight on one of the two halves of the ring and nine on the other half.

6. The cable dressing ring of claim 4, wherein the ring has eighteen cable holders, nine on each of the two halves of the ring.

7. The cable dressing ring of claim 4, wherein the ring has fourteen cable holders, seven on each of the two halves of the ring.

8. The cable dressing ring of claim 4, wherein the ring has twelve cable holders, six on each of the two halves of the ring.

9. The cable dressing ring of claim 4, wherein the joint mechanism comprises two joint members, and wherein, each of the two joint members form a unit with one of the halves of the ring, wherein the unit is obtained by molding one joint member and one of the halves of the ring together, as one piece, during manufacturing.

10. The cable dressing ring of claim 8, wherein the locking mechanism comprises two locking members, and wherein, each of the two locking members form with one of the halves of the ring a unit, which is obtained by molding one locking member and one half of the ring together, as one piece, during manufacturing.
